(19) United States
(12) Patent Application Publication
(10) Pub. No.: US 2007/0168885 A1
(43) Pub. Date: Jul. 19, 2007

(54) SORTING AND FILTERING ACTIVITIES IN AN ACTIVITY-CENTRIC COLLABORATIVE COMPUTING ENVIRONMENT

(76) Inventors: Michael Muller, Medford, MA (US); Andrew L. Schirmer, Andover, MA (US); Werner Geyer, Boston, MA (US); Eric M. Wilcox, Cambridge, MA (US); Sandra L. Kogan, Newton, MA (US); Charles R. Hill, Belmont, MA (US); Martin T. Moore, Somerville, MA (US); Elizabeth A. Brownholtz, Andover, MA (US); David R. Millen, Boxford, MA (US); Paul B. Moody, Hyde Park, VT (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(21) Appl. No.: 11/617,065

(22) Filed: Dec. 28, 2006

Related U.S. Application Data
(63) Continuation-in-part of application No. 11/039,977, filed on Jan. 21, 2005.

(51) Int. Cl. G06F 17/30

(52) U.S. Cl. 715/853; 707/3

(57) ABSTRACT

Embodiments of the present invention address deficiencies of the art in respect to managing the scatter and flood problem of the activity-centric computing environment and provide a method, system and computer program product for sorting and filtering activities in an activity-centric computing environment. In one embodiment of the invention, a method for filtering and sorting activity objects in an activity-centric computing environment can include generating at least one activity thread of hierarchically arranged activity objects, selecting at least one filtering criterion for the activity objects, and filtering the activity objects in the activity threads. Additionally, a filtered view of the activity objects can be generated in an activity map in the activity-centric computing environment.

### CROSS-REFERENCE TO RELATED APPLICATIONS

This patent application claims the benefit under 35 U.S.C. § 120 as a continuation-in-part of presently pending U.S. patent application Ser. No. 11/039,977, entitled SYSTEM, METHOD AND APPARATUS FOR CREATING AND MANAGING ACTIVITIES IN A COLLABORATIVE COMPUTING ENVIRONMENT filed on Jan. 21, 2005, the entire teachings of which are incorporated herein by reference.

### BACKGROUND OF THE INVENTION

1. Field of the Invention

The present invention relates to the field of collaborative computing and more particularly to activity-centric collaborative computing.

2. Description of the Related Art

Collaborative computing refers to the use by two or more end users of a computing application in order to achieve a common goal. Initially envisioned as a document sharing technology among members of a small workgroup in the corporate environment, collaborative computing has grown today to include a wide variety of technologies arranged strategically to facilitate collaboration among groups as small as two people, or as large as a world-wide community. Thus, different collaborative applications may focus on groups of different sizes. No longer merely restricted to document sharing, the modern collaborative environment can include document libraries, chat rooms, video conferencing, application sharing, and discussion forums to name only a few.

A collaborative computing application enjoys substantial advantages over a more conventional, individualized computing application. Specifically, at present it is rare that a goal of any importance is entrusted and reliant upon a single person. In fact, many goals and objectives can be achieved only through the participation of a multiplicity of individuals, each serving a specified role or roles in the process. Consequently, to provide computing tools designed for use only by one of the individuals in the process can be short sighted and can ignore important potential contributions from among the other individuals involved in the process.

Early versions of the collaborative computing application include the personal information manager (PIM) and the project management system and center around the management of contacts and tasks, respectively. Neither the PIM nor the project management system, however, accounts for the actual nature of a coordinated set of collaborative tasks conducted by people, such as an activity. An activity, unlike a typical to-do or project task, refers to objects, actions, and persons in the real world, and provides a computerized representation of selected aspects of those objects, actions, and persons. As is well known, human work is notoriously situational and changeable in that humans discover new aspects of problems, develop new understandings of constraints, adapt to changed conditions, and inform their colleagues about these new circumstances.

Regarding this changeable, re-interpretable, shared human work, conventional technologies such as the PIM and the project management system fail to provide a flexible, collaborative computerized representation of a coordinated set of collaborative tasks. Rather, the PIM provides merely flexible, but private representations of collaborative tasks. By comparison, the project management system provides shared representations of project components in which one user typically specifies a fixed set of components and their interdependencies for use by other users. Furthermore, in project management systems, other users are relegated to the task of updating not the interdependencies, but merely the status of the specified components within those strict interdependencies.

Modern collaboration tools address the deficiencies of the PIM and project manager by combining e-mail with other functions to integrate e-mail seamlessly into end user daily activities in an activity-centric collaboration tool. Activity-centric collaboration tools recognize that it is not enough to help people manage their e-mail, but to help people manage their work by associating communications and information feeds around a topic or activity. In an activity-centric collaboration tool, e-mail messages, synchronous communication such as instant messages, screen images, files, folders and to-do lists can be combined into an activity thread by one or many members of a project team allowing the project team to switch easily between asynchronous and real-time collaboration.

In this regard, an activity thread might include the messages, chats and files exchanged among members of a team participating in a group project. More specifically, an activity object such as a task description can be associated with meta-data, which can include for example one or more persons related to that activity, their respective roles such as “assigner” and “assignee,” and various dates such as the date-of-assignment, the date-due, the date-actually-completed, and so on.

While an activity-centric computing environment can be effective in marshalling resources and efforts in the completion of an activity, interacting with an activity-centric computing environment can become challenging when the number of objects across multiple activity threads becomes large. Referred to as the “scatter and flood”, in an extensively used activity-centric computing environment, work can be scattered across multiple repositories such that collaborators are constantly flooded with alerts pertaining to many different activity objects, communications and responsibilities in many different activity threads. Bundling objects together into larger collections, whether structured or otherwise, can exacerbate the flood problem as alerts will be sent to individual users associated with the objects in the bundled collection irrespective of the interests of the individual users.

### BRIEF SUMMARY OF THE INVENTION

Embodiments of the present invention address deficiencies of the art in respect to managing the scatter and flood problem of the activity-centric computing environment and provide a method, system and computer program product for sorting and filtering activities in an activity-centric computing environment. In one embodiment of the invention, a method for filtering and sorting activity objects in an activity-centric computing environment can include generating at least one activity thread of hierarchically arranged activity objects, selecting at least one filtering criterion for the activity objects, and filtering the activity objects in the activity threads. Additionally, a filtered view of the activity objects can be generated in an activity map in the activity-centric computing environment.

In one aspect of the embodiment, generating a filtered view of the activity objects in an activity map in the activity-centric computing environment can include selecting at least one sorting criterion for the filtered activity objects, sorting the filtered activity objects, and generating the filtered view with the sorted filtered activity objects. In both the case of filtering and sorting, the respective criterion can include filtering or sorting by object type, by date or date range of the activity object, by person associated with the activity object, by role associated with the activity object, and by completion status of the activity.

In another embodiment of the invention, an activity-centric collaborative data processing system can be provided. The system can include an activity list view including a listing of activities, each of the activities including at least one task. The system further can include an activity view including a rendering of properties associated with a selected activity in the activity list view. The system yet further can include a persons and roles view including at least a listing of collaborators available for association with the selected activity in the activity list view. Finally, the system can include an activity object filter coupled to filtering criterion and an activity map including a view of an activity thread of activity objects for a selected one of the activities in the activity list view wherein the view is filtered according to selected ones of the filtering criterion.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIGS. 1A and 1B, taken together, are a pictorial illustration of a unified activity manager configured for filtering and sorting of activities; and,

FIG. 2 is a block diagram illustrating a computing architecture for an activity-centric data processing system configured for sorting and filtering of activities.

### DETAILED DESCRIPTION OF THE INVENTION

Embodiments of the present invention provide a method, system and computer program product for filtering and sorting of activity objects in an activity-centric computing environment. In accordance with an embodiment of the present invention, activity objects across multiple different activity threads in an activity-centric collaboration environment can be filtered according a selected filter criterion. Additionally, the filtered activity objects can be sorted according to a selected sorting criterion. In this way, a collaborator can view a selection of activity objects irrespective of the activity thread in which the activity objects appear.

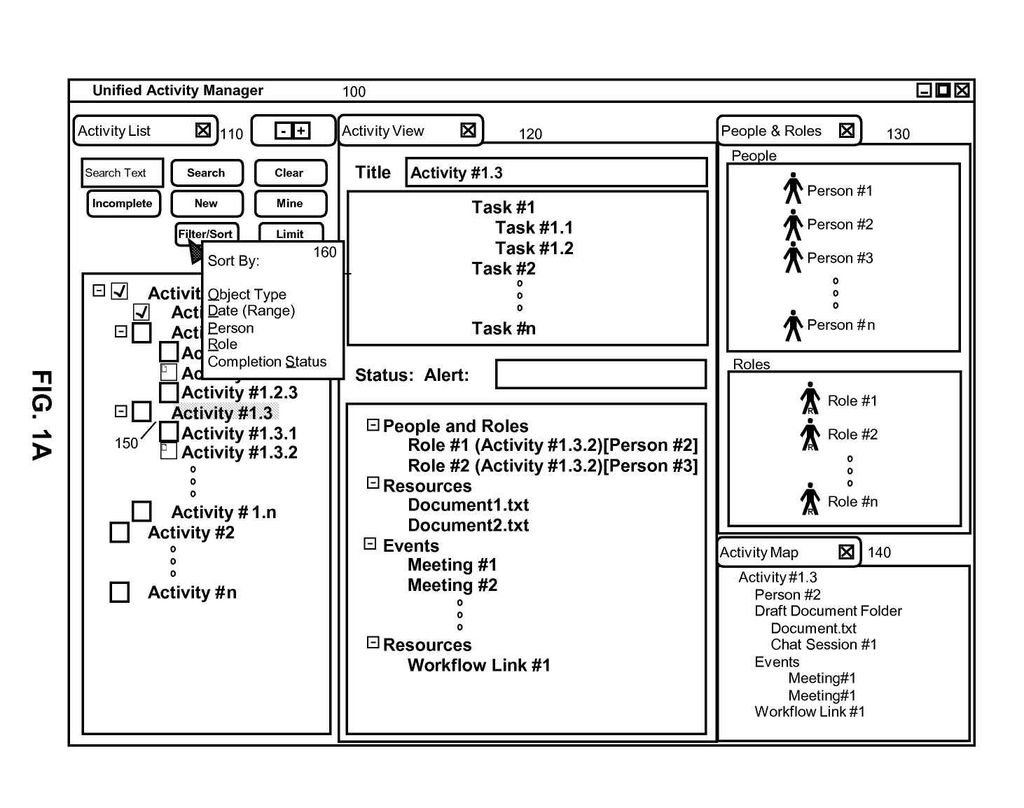

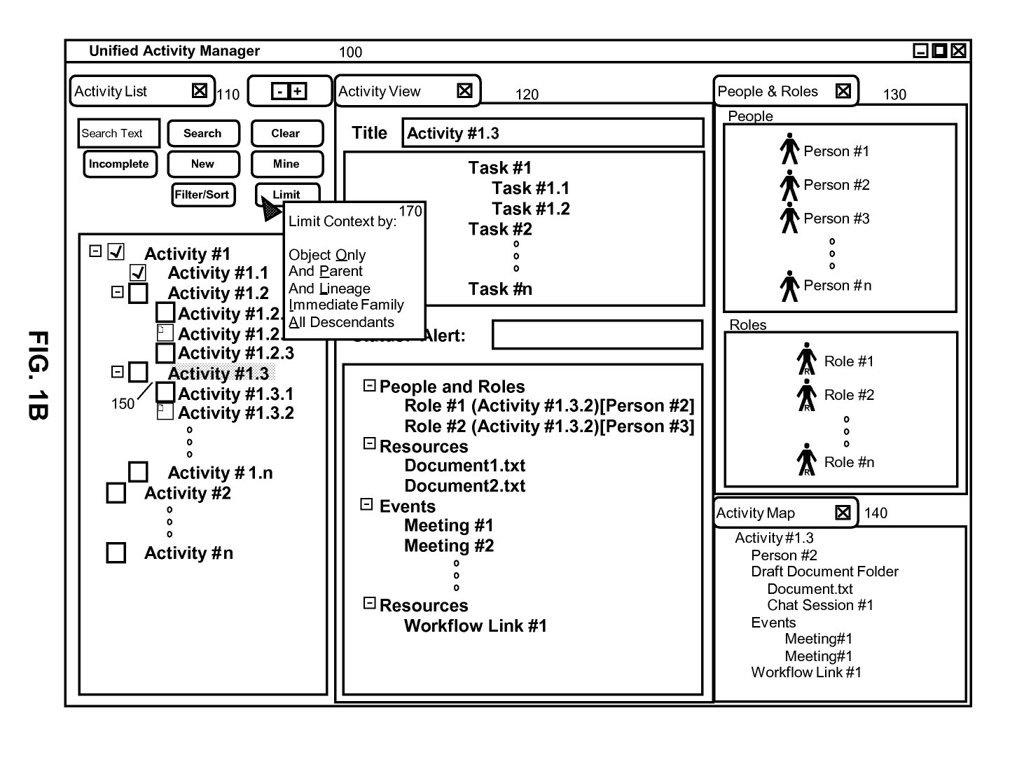

In further illustration, FIGS. 1A and 1B, taken together, are a pictorial illustration of a unified activity manager which has been configured for sorting and filtering of activities. The unified activity manager 100 can include several views including an activity list view 110, an activity view 120, a people and roles view 130 and an activity map 140. The activity list view 110 can include a listing of one or more activities. Each activity can be decomposed into zero or more dependent activities, which together comprise a richer description of the work summarized in the original activity.

Each of these dependent activities is itself an activity, but appears in a subactivity-relationship to the original activity. This process of defining activities in subactivity-relationship may be extended to any desired level of dependent description. The activity view 120 can include a description of a task that is contained within the activity. The task description can include one or more tasks associated with the activity. Additionally, tasks can be decomposed into zero or more dependent tasks, which together comprise a richer procedural specification of the original task. Each of these dependent tasks is itself a task, but appears in a subtask-relationship to the original task. This process of specifying tasks in subtask-relationship may be extended to any desired level of dependent specification.

The activity view 120 further can include a detailed listing of the properties of a selected activity 150 in the activity list view 1 10. Specifically, the detailed listing can include a listing of collaborators (people) specified for the activity. Also, the detailed listing can include a listing of collaborator roles (roles) specified for the activity. Further, the detailed listing can include a listing of events specified for the activity. Finally, the detailed listing can include a listing of links to internal workflows, external workflows or both.

The peoples and roles view 130 can include a listing of collaborators in the collaborative environment available for assignment to a specified activity in the activity list view 110. The peoples and roles view 130 also can include a listing of collaborative roles in the collaborative environment available for assignment to a specified activity in the activity list view 110. In this regard, a role can be compared to a person in that a person references a specific identity and a role references only a class of persons.

An activity map 140 yet further can be provided. The activity map 140 can include a view to an activity thread—an arranged set of electronic mail messages, calendar entries, documents, files and file folders, and applications, such as an application share, discussion thread or chat session, to name a few. The activity objects in the activity thread of the activity map 140 can be both sorted and filtered according to specified criterion. For example, as shown in FIG. 1A, the filtering and sorting criterion 160 can include by object type, by date or date range of the activity object, by person associated with the activity object, by role associated with the activity object, and by completion status of the activity. Finally, as an option, a programmatic interface to the filtered activity objects to provide the filtered activity objects to requesting external program logic.

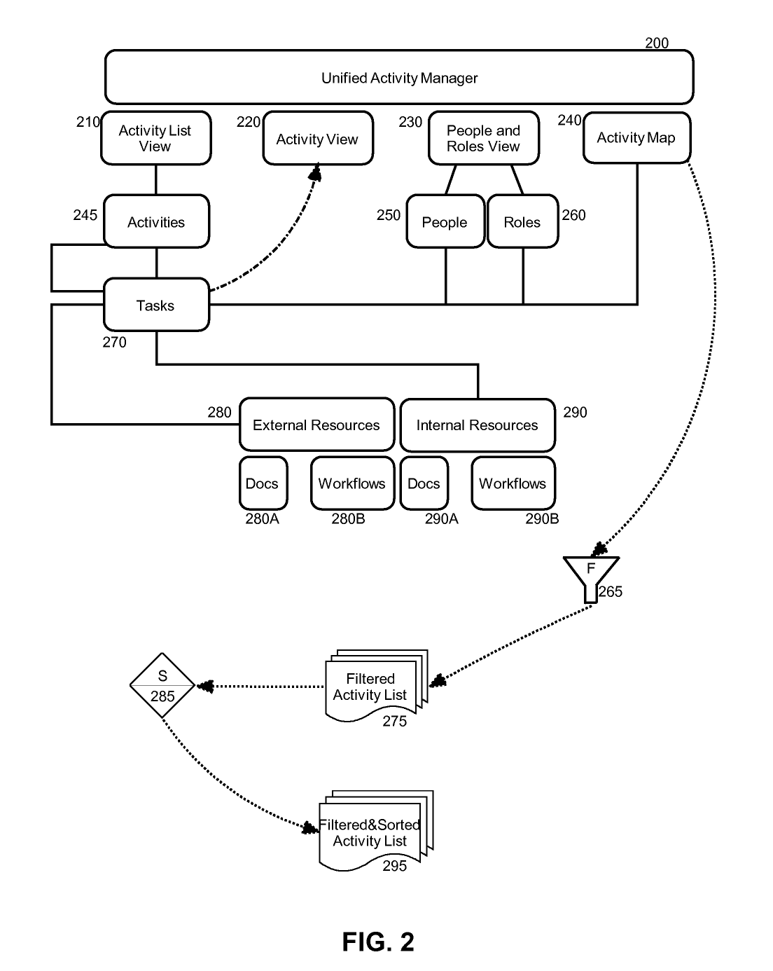

The resulting subset of activity objects can further be limited by context according to context limiting criterion. As shown in FIG. 1B, the context limiting criterion 170 can include the activity object only, the activity object and its parent, the activity object and its predecessors, the activity object and its immediate parent and children, and all descendants of the activity object. In yet further illustration, FIG. 2 is a block diagram showing a computing architecture for the unified activity manager of FIGS. 1A and 1B, configured for sorting and filtering of activities.

The architecture can include the unified activity manager 200 which can have an activity list view 210, an activity view 220, a people and roles view 230 and an activity map 240 of activity objects arranged hierarchically in an activity thread. The activity list view 210 can include one or more activities 245, each activity 245 having one or more tasks 270 or even other activities 245 defined through a sub-activity relationship. The activity view 220 can include a visual rendering of the properties of a selected one of the activities 270. Finally, the people and roles view 230 can include one or more people 250 and one or more roles 260. Importantly, references to the people 250 and roles 260 can be included in the tasks 270.

In accordance with the present invention, each of the tasks 270 optionally can include links to both internal resources 280 and external resources 290. The internal resources 280 can include internally disposed documents 280A and internally specified workflows 280B to name only two. Similarly, the external resources 290 can include externally disposed documents 290A and externally specified workflows 290B. Other resources not shown can include references to internally available collaborative tools including application shares, chat sessions, document libraries, and e-mail messages, to name a few.

Utilizing the architecture of FIG. 2, activities can be created and managed so as to facilitate the collaborative achievement of a goal without requiring the use of a rigid, non-collaborative, PIM or project management system. Rather, the activities can represent an informal and flexible structuring of to-dos and resources, collectively activity objects, which can permit the collaborative execution of the activity in a conversational manner, regardless of the sequence of completion of the to-dos and irrespective of whether all tasks in the activity are completed.

Importantly, a filter 265 can be coupled to the activity map 240. The filter 265 can provide program code logic enabled to filter a set of activity objects for an activity thread in the activity map 240 according to one or more filtering criterion. The filtering criterion can include, for example, by object type, by date or date range of the activity object, by person associated with the activity object, by role associated with the activity object, and by completion status of the activity. The filtering criterion further can include filtering by relatedness, such as objects with or without children, objects at a particular depth in the hierarchy defined by the activity thread, objects having a threshold number of parents, or objects that have been accessed within a specified time frame. The filtering criterion yet further can include filtering by status of the activity object.

The result of the filtering applied by the filter 265 can include a filtered list of activity objects 275. The filtered list of activity objects 275 further can be subjected to sorting 285 according to sorting criterion to produce a filtered and sorted set of activity objects 295 for display in the activity map 240. The sorting criterion can include, for example, by object type, by date or date range of the activity object, by person associated with the activity object, by role associated with the activity object, and by completion status of the activity. The sorting criterion further can include sorting by relatedness, such as objects with or without children, objects at a particular depth in the hierarchy defined by the activity thread, objects having a threshold number of parents, or objects that have been accessed within a specified time frame.

The resulting filtered and sorted set of activity objects 295 can be displayed hierarchically in the activity map 240, or optionally in a roll-up view in the activity map 240. Additionally, pre- established filtering and sorting criterion can be persisted for subsequent rapid use. Additionally, multiple filtering and sorting criterion can be applied to the activity objects in the activity map 240 to produce a specific desired view of the filtered and sorted activity objects 295.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for filtering and sorting activity objects in an activity-centric computing environment, the method comprising:
generating at least one activity thread of hierarchically arranged activity objects;
selecting at least one filtering criterion for the activity objects; and, filtering the activity objects in the at least one activity thread.

2. The method of claim 1, further comprising generating a filtered view of the activity objects in an activity map in the activity-centric computing environment.

3. The method of claim 1, further comprising providing a programmatic interface to the filtered activity objects for use by external program logic.

4. The method of claim 1, wherein selecting at least one filtering criterion for the activity objects, comprises selecting at least one filtering criterion selected from the group consisting of by object type, by date or date range of the activity object, by person associated with the activity object, by role associated with the activity object, and by completion status of the activity.

5. The method of claim 1, wherein selecting at least one filtering criterion for the activity objects, comprises selecting at least one filtering criterion selected from the group consisting of by relatedness and by activity object status.

6. The method of claim 1, wherein filtering the activity objects in the at least one activity thread, further comprises limiting the filtered objects according to object context.

7. The method of claim 6, wherein limiting the filtered objects according to object context, comprises limiting the filtered objects according to an object context selected from the group consisting of object only, object and parent, object and lineage, object and immediate family, and object and all descendants.

8. The method of claim 2, wherein generating a filtered view of the activity objects in an activity map in the activity-centric computing environment, comprises:
selecting at least one sorting criterion for the filtered activity objects;
sorting the filtered activity objects; and,
generating the filtered view with the sorted filtered activity objects.

9. The method of claim 8, wherein selecting at least one sorting criterion for the activity objects, comprises selecting at least one sorting criterion selected from the group consisting of by object type, by date or date range of the activity object, by person associated with the activity object, by role associated with the activity object, and by completion status of the activity.

10. The method of claim 8, wherein selecting at least one sorting criterion for the activity objects, comprises selecting at least one sorting criterion selected from the group consisting of by relatedness and by activity object status.

11. The method of claim 8, wherein generating the filtered view with the sorted filtered activity objects, comprises generating a roll-up view of the sorted filtered activity objects.

12. An activity-centric collaborative data processing system, comprising:
an activity list view comprising a listing of activities, each of the activities comprising at least one task;
an activity view comprising a rendering of properties associated with a selected activity in the activity list view;
a persons and roles view comprising at least a listing of collaborators available for association with the selected activity in said activity list view;
an activity object filter coupled to a plurality of filtering criterion; and,
an activity map comprising a view of an activity thread of activity objects for a selected one of the activities in the activity list view, the view being filtered according to selected ones of the filtering criterion.

13. The system of claim 12, wherein the activity objects in the activity map are further sorted according to selected sorting criterion.

14. A computer program product comprising a computer usable medium embodying computer usable program code for filtering and sorting activity objects in an activity-centric computing environment, the computer program product comprising:
computer usable program code for generating at least one activity thread of hierarchically arranged activity objects;
computer usable program code for selecting at least one filtering criterion for the activity objects; and,
computer usable program code for filtering the activity objects in the activity threads.

15. The computer program product of claim 14, further comprising computer usable program code for generating a filtered view of the activity objects in an activity map in the activity-centric computing environment.

16. The computer program product of claim 14, further comprising computer usable program code for providing a programmatic interface to the filtered activity objects for use by external program logic.

17. The computer program product of claim 14, wherein the computer usable program code for selecting at least one filtering criterion for the activity objects, comprises computer usable program code for selecting at least one filtering criterion selected from the group consisting of by object type, by date or date range of the activity object, by person associated with the activity object, by role associated with the activity object, and by completion status of the activity.

18. The computer program product of claim 14, wherein the computer usable program code for selecting at least one filtering criterion for the activity objects, comprises computer usable program code for selecting at least one filtering criterion selected from the group consisting of by relatedness and by activity object status.

19. The computer program product of claim 14, wherein the computer usable program code for filtering the activity objects in the activity threads, further comprises computer usable program code for limiting the filtered objects according to object context.

20. The computer program product of claim 19, wherein the computer usable program code for limiting the filtered objects according to object context, comprises computer usable program code for limiting the filtered objects according to an object context selected from the group consisting of object only, object and parent, object and lineage, object and immediate family, and object and all descendants.

21. The computer program product of claim 16, wherein the computer usable program code for generating a filtered view of the activity objects in an activity map in the activity-centric computing environment, comprises:
computer usable program code for selecting at least one sorting criterion for the filtered activity objects;
computer usable program code for sorting the filtered activity objects; and,
computer usable program code for generating the filtered view with the sorted filtered activity objects.

22. The computer program product of claim 21, wherein the computer usable program code for selecting at least one sorting criterion for the activity objects, comprises computer usable program code for selecting at least one sorting criterion selected from the group consisting of by object type, by date or date range of the activity object, by person associated with the activity object, by role associated with the activity object, and by completion status of the activity.

23. The computer program product of claim 21, wherein the computer usable program code for selecting at least one sorting criterion for the activity objects, comprises computer usable program code for selecting at least one sorting criterion selected from the group consisting of by relatedness and by activity object status.

24. The computer program product of claim 21, wherein the computer usable program code for generating the filtered view with the sorted filtered activity objects, comprises computer usable program code for generating a roll-up view of the sorted filtered activity objects.
